(19) United States
(12) Patent Application Publication
(10) Pub. No.: US 2025/0137493 A1
(43) Pub. Date: May 1, 2025

(54) TRIPOD TYPE CONSTANT VELOCITY UNIVERSAL JOINT

(71) Applicant: JTEKT CORPORATION, Kariya-shi (JP)

(72) Inventors: Kenta MIZUTANI, Aichi (JP); Keishi KOBATA, Aichi (JP); Kenji OISO, Aichi (JP); Takuya MOTOOKA, Aichi (JP); Akihiko HASEGAWA, Aichi (JP)

(73) Assignee: JTEKT CORPORATION, Kariya-shi (JP)

(21) Appl. No.: 18/835,379

(22) PCT Filed: Mar. 11, 2022
(86) PCT No.: PCT/JP2022/011095

§ 371 Date: Aug. 2, 2024

(51) Int. Cl. F16D 3/205; F16D 3/223

(52) U.S. Cl. CPC F16D 3/2055; F16D 3/223; F16D 2003/22309

(57) ABSTRACT

A groove-orthogonal sectional shape of a ceiling surface of a raceway groove of an outer ring of a tripod type constant velocity universal joint is a line shape including at least part of a target contour line located away from a central axis of the outer ring in a contour line obtained by projecting a roller end face in an axial direction of the outer ring when a roller pitches by a predetermined angle.

### TECHNICAL FIELD

The present disclosure relates to a tripod type constant velocity universal joint.

### BACKGROUND ART

In a tripod type constant velocity universal joint described in Patent Document 1, an outer ring has raceway grooves in which rollers roll. The groove-orthogonal sectional shape of the ceiling surface (groove bottom surface) of the raceway groove of the outer ring is formed in a circular arc shape centered on a central axis of the outer ring.

### RELATED ART DOCUMENTS

### Patent Documents

Patent Document 1: Japanese Unexamined Patent Application Publication No. 2004-257569 (JP 2004-257569 A)

### SUMMARY OF THE INVENTION

### Problem to be Solved by the Invention

In the tripod type constant velocity universal joint, when the roller comes into contact with the ceiling surface of the raceway groove of the outer ring during pitching, friction is generated due to the contact. This friction causes a forcing power that induces vibration in the tripod type constant velocity universal joint. When the groove-orthogonal sectional shape of the ceiling surface of the raceway groove of the outer ring is formed in the circular arc shape centered on the central axis of the outer ring as in the tripod type constant velocity universal joint described in Patent Document 1, it is possible to suppress the contact of the roller with the ceiling surface of the raceway groove of the outer ring during pitching.

When the roller pitches, however, a clearance is present between the roller and the ceiling surface of the raceway groove of the outer ring. There is room for improvement in terms of reduction in the size and weight of the outer ring.

The present disclosure has been made in view of such a problem, and provides a tripod type constant velocity universal joint that can achieve reduction in the size and weight of an outer ring.

### Means for Solving the Problem

One aspect of the present disclosure is a tripod type constant velocity universal joint including an outer ring having a plurality of raceway grooves extending in an axial direction, a tripod including a plurality of tripod shaft portions extending radially outward, and rollers externally fitted onto the tripod shaft portions and configured to roll in the raceway grooves. The raceway groove includes a first raceway surface constituting one groove side surface, a second raceway surface constituting another groove side surface, and a ceiling surface constituting a groove bottom surface. The roller includes a roller outer circumferential surface configured to roll on the first raceway surface or the second raceway surface, and a roller end face that is an axial end face of the roller that faces the ceiling surface. A groove-orthogonal sectional shape of the ceiling surface is a line shape including at least part of a target contour line located away from a central axis of the outer ring in a contour line obtained by projecting the roller end face in the axial direction of the outer ring when the roller pitches by a predetermined angle.

### Effects of the Invention

In the tripod type constant velocity universal joint of the above aspect, the groove-orthogonal sectional shape of the ceiling surface of the raceway groove of the outer ring is the line shape including at least part of the target contour line. The target contour line is a line located away from the central axis of the outer ring in the contour line obtained by projecting the roller end face in the axial direction of the outer ring when the roller pitches by the predetermined angle.

That is, when the roller pitches by the predetermined angle, part of the roller end face comes into contact with the ceiling surface of the raceway groove of the outer ring. When the roller pitches by an angle smaller than the predetermined angle, a small clearance is present between the ceiling surface and the roller. Thus, the generation of the forcing power can be suppressed when the roller pitches by an angle smaller than the predetermined angle.

When the roller pitches by the predetermined angle, part of the roller comes into contact with the ceiling surface, which means that the ceiling surface is positioned closer to the center of the outer ring compared to a case where the groove-orthogonal sectional shape of the ceiling surface is a circular arc shape centered on the central axis of the outer ring. Thus, the size of the outer ring can be reduced and, as a result, the weight of the outer ring can be reduced. Furthermore, the size and weight of the tripod type constant velocity universal joint can be reduced.

As described above, according to the above aspect, it is possible to provide the tripod type constant velocity universal joint that can achieve reduction in the size and weight of the outer ring.

Reference signs in parentheses in the claims represent the corresponding relationships with specific means described in embodiments described later, and are not intended to limit the technical scope of the present invention.

### BRIEF DESCRIPTION OF THE DRAWINGS

FIG. 1 is a diagram of a tripod type constant velocity universal joint of a first embodiment as viewed in an axial direction, showing a case where a joint angle is 0° and showing only a portion of one raceway groove of an outer ring.

FIG. 2 is a sectional view taken along line II-II in FIG. 1, and is an axial partial sectional view of the tripod type constant velocity universal joint.

FIG. 3 is a sectional view taken along line III-III in FIG. 2, and is a radial partial sectional view of the tripod type constant velocity universal joint.

FIG. 4 is a partial view of the tripod type constant velocity universal joint as viewed in the axial direction when the joint angle is θp1 and a roller pitches by a pitching angle θp1.

FIG. 5 is a sectional view taken along line V-V in FIG. 4, and is an axial partial sectional view of the tripod type constant velocity universal joint when the joint angle is θp1. FIG. 6 is an axial partial sectional view of the tripod type constant velocity universal joint when the joint angle is θp2 and the roller pitches by a pitching angle θp2.

FIG. 7 is a diagram showing only the outer ring and the roller as viewed from a left side of FIG. 6, that is, in the axial direction of the outer ring.

FIG. 8 is a diagram illustrating a groove-orthogonal sectional shape of a ceiling surface of the raceway groove of the outer ring, in which (a) is a diagram showing a contour line OL1, (b) is a diagram showing a target contour line OL1a, and (c) is a diagram showing the groove-orthogonal sectional shape of the ceiling surface of the raceway groove of the outer ring.

FIG. 9 is a diagram illustrating the shape of the ceiling surface of the raceway groove of the outer ring according to a modification of the first embodiment.

FIG. 10 is a diagram illustrating a groove-orthogonal sectional shape of a ceiling surface of a raceway groove of an outer ring constituting a tripod type constant velocity universal joint of a second embodiment, in which (a) is a diagram showing a first contour line OL2 and a first target contour line OL2a in a state in which a roller is in contact with a first raceway surface, (b) is a diagram showing a second contour line OL3 and a second target contour line OL3a in a state in which the roller is in contact with a second raceway surface, (c) is a diagram showing shape lines OL2a, OL3a, OL4 in a target range, and (d) is a diagram showing the groove-orthogonal sectional shape of the ceiling surface of the raceway groove of the outer ring.

FIG. 11 is a diagram illustrating the shape of the ceiling surface of the raceway groove of the outer ring according to a modification of the second embodiment.

### MODES FOR CARRYING OUT THE INVENTION

### First Embodiment

### 1. Configuration of Tripod Type Constant Velocity Universal Joint 1

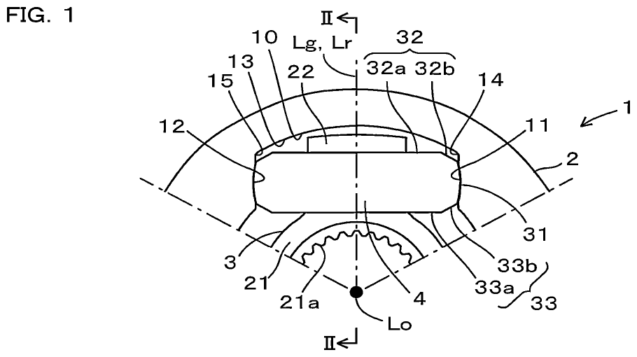

The configuration of a tripod type constant velocity universal joint 1 of the present embodiment will be described with reference to FIGS. 1 to 3. The tripod type constant velocity universal joint 1 is used, for example, in a drive shaft or a propeller shaft of a vehicle. The tripod type constant velocity universal joint 1 includes an outer ring 2, a tripod 3, and rollers 4.

The outer ring 2 is formed in a tubular shape with a bottom, and has three raceway grooves 10 extending in an axial direction on its inner circumferential surface. The three raceway grooves 10 are positioned at equal intervals in a circumferential direction. FIGS. 1 to 3 show only one raceway groove 10. In the following description, a groove-orthogonal cross section is a cross section orthogonal to the direction in which the raceway groove 10 extends, and a groove-direction cross section is a cross section in the direction in which the raceway groove 10 extends. A line that is orthogonal to a central axis Lo of the outer ring 2 and passes through the center of the raceway groove 10 in a groove width direction is defined as a raceway groove center line Lg.

The raceway groove 10 includes a first raceway surface 11 constituting one groove side surface, and a second raceway surface 12 constituting the other groove side surface. The first raceway surface 11 and the second raceway surface 12 face each other. The groove-orthogonal sectional shape of each of the first raceway surface 11 and the second raceway surface 12 is a curved concave shape in the groove-orthogonal cross section of the raceway groove 10. The groove-orthogonal sectional shape of each of the first raceway surface 11 and the second raceway surface 12 is, for example, a Gothic arc shape in which two circular arcs are connected.

The raceway groove 10 further includes a ceiling surface 13 constituting a groove bottom surface. The detailed shape of the ceiling surface 13 will be described later. In the present embodiment, the raceway groove 10 includes a first recessed surface 14 and a second recessed surface 15. The first recessed surface 14 is a portion connecting the first raceway surface 11 and the ceiling surface 13, and is positioned at one groove bottom corner portion. The second recessed surface 15 is a portion connecting the second raceway surface 12 and the ceiling surface 13, and is positioned at the other groove bottom corner portion. The groove-orthogonal sectional shape of each of the first recessed surface 14 and the second recessed surface 15 is a curved concave shape having a smaller radius of curvature than those of the first raceway surface 11, the second raceway surface 12, and the ceiling surface 13.

The tripod 3 is a member attached to a shaft that is not shown, and constitutes an inner member housed in the outer ring 2. The tripod 3 includes a boss portion 21 and three tripod shaft portions 22. The boss portion 21 is formed in a tubular shape, and includes a spline formed on its inner circumferential surface so that it can be fitted to the shaft.

The tripod shaft portion 22 is a shaft member extending radially outward from the outer circumferential surface of the boss portion 21. The tripod shaft portion 22 is formed in a columnar shape, a spherical shape, etc. For example, the tripod shaft portion 22 formed in the columnar shape may have a circular columnar shape, an elliptical columnar shape, or a composite columnar shape in which part of a circular column or an elliptical column is formed into a planar shape. In the present embodiment, the column sectional shape of the tripod shaft portion 22 includes a pair of convex curved portions constituting an ellipse, and straight portions connecting the convex curved portions.

The roller 4 is externally fitted onto the tripod shaft portion 22, and is slidable in the axial direction of the tripod shaft portion 22. The roller 4 rolls in the raceway groove 10 of the outer ring 2 while being externally fitted onto the tripod shaft portion 22. When transmitting torque between the roller 4 and the first raceway surface 11, the roller 4 rolls on the first raceway surface 11. When transmitting torque between the roller 4 and the second raceway surface 12, the roller 4 rolls on the second raceway surface 12.

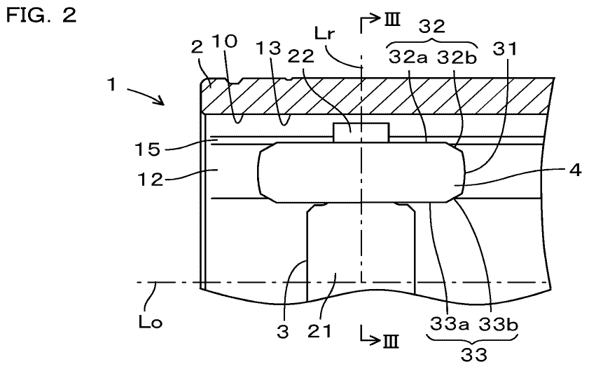

As shown in FIGS. 1 and 2, the outer shape of the roller 4 includes a roller outer circumferential surface 31, a roller end face 32, and a roller base surface 33. The roller outer circumferential surface 31 is configured to roll on the first raceway surface 11 or the second raceway surface 12. The roller outer circumferential surface 31 is formed, for example, in a spherical shape centered on a point on a central axis Lr of the roller 4.

The roller end face 32 is one of the axial end faces of the roller 4 that faces the ceiling surface 13. In the present embodiment, the roller end face 32 includes a circular flat portion 32a and a chamfered portion 32b. The circular flat portion 32a is formed in a disc shape centered on the central axis Lr of the roller 4 and parallel to a plane orthogonal to the axis of the roller 4. The chamfered portion 32b is a surface connecting the outer circumferential edge of the circular flat portion 32a and the roller outer circumferential surface 31, and is formed in a partial conical shape inclined with respect to the plane orthogonal to the axis of the roller 4.

The roller base surface 33 is one of the axial end faces of the roller 4 that is opposite to the roller end face 32. In the present embodiment, the roller base surface 33 is formed in a plane symmetrical shape to the roller end face 32. The roller base surface 33 includes a circular flat portion 33a and a chamfered portion 33b. The circular flat portion 33a is formed in a disc shape centered on the central axis Lr of the roller 4 and parallel to the plane orthogonal to the axis of the roller 4. The chamfered portion 33b is a surface connecting the outer circumferential edge of the circular flat portion 33a and the roller outer circumferential surface 31, and is formed in a partial conical shape inclined with respect to the plane orthogonal to the axis of the roller 4.

The roller 4 may be of either a single roller type or a double roller type. For example, the roller 4 of the single roller type includes an outer roller and a plurality of needle bearings arranged between the outer circumferential surface of the tripod shaft portion 22 and the inner circumferential surface of the outer roller. The roller 4 of the double roller type includes an outer roller, an inner roller, and a plurality of needle bearings arranged between the outer roller and the inner roller. The roller 4 may be tiltable or non-tiltable relative to the tripod shaft portion 22.

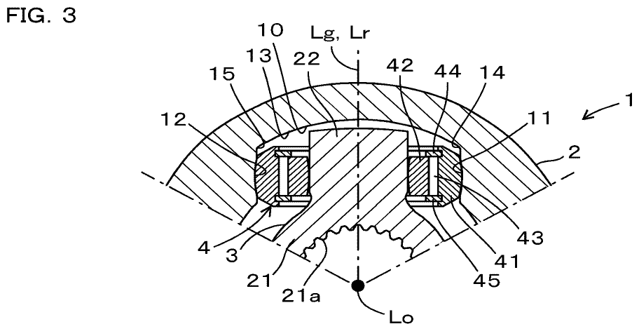

In the present embodiment, the roller 4 is of the double roller type as shown in FIG. 3. The roller 4 includes an outer roller 41, an inner roller 42, a plurality of needle bearings 43, and snap rings 44, 45. The outer circumferential surface of the outer roller 41 is configured to roll on the first raceway surface 11 and the second raceway surface 12.

The axial sectional shape of the inner circumferential surface of the inner roller 42 is, for example, a curved shape that is convex radially inward. The inner roller 42 is externally fitted onto the outer circumferential surface of the tripod shaft portion 22, and is tiltable relative to the tripod shaft portion 22. The plurality of needle bearings 43 is interposed between the inner circumferential surface of the outer roller 41 and the outer circumferential surface of the inner roller 42. The snap rings 44, 45 are latched to the outer roller 41, and engage with the inner roller 42 and the plurality of needle bearings 43 to position the inner roller 42 and the plurality of needle bearings 43.

### 2. Operation of Tripod Type Constant Velocity Universal Joint 1

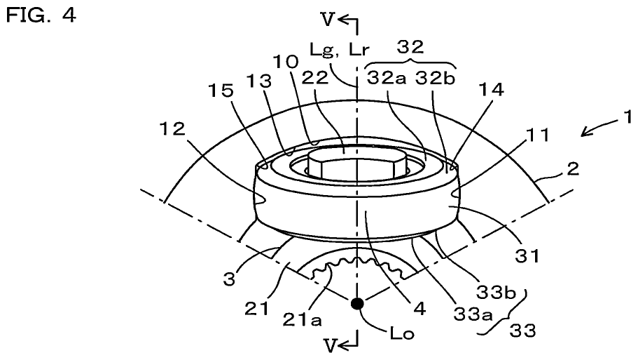

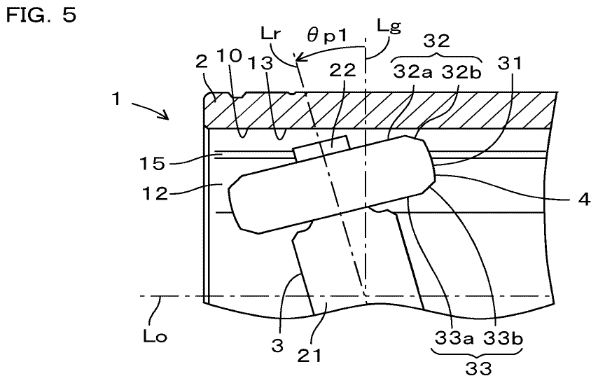

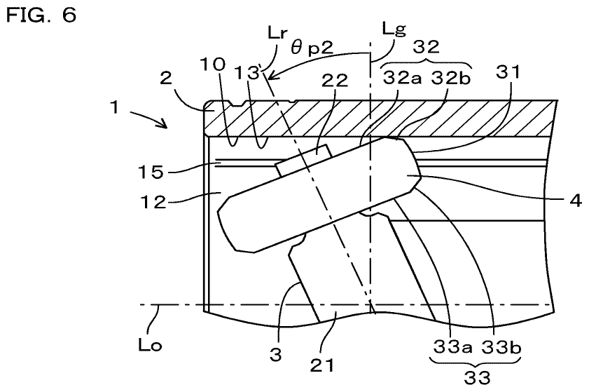

The operation of the tripod type constant velocity universal joint 1 will be described with reference to FIGS. 4 and 5. As shown in FIGS. 4 and 5, the angle between the central axis Lo of the outer ring 2 and the central axis of the tripod 3 is a joint angle. When the central axis Lr of the roller 4 agrees with the central axis of the tripod shaft portion 22, the angle between the raceway groove center line Lg and the central axis Lr of the roller 4 is equal to the joint angle. FIGS. 4 and 5 show a state in which the joint angle is θp1.

When the joint angle is θp1 and the tripod type constant velocity universal joint 1 rotates, torque is transmitted between the outer ring 2 and the tripod 3 via the roller 4. At this time, the roller 4 rolls on the first raceway surface 11 or the second raceway surface 12 and moves back and forth in the raceway groove 10 while pitching relative to the raceway groove 10.

A maximum joint angle φ1 of the tripod type constant velocity universal joint 1 during straightforward traveling of the vehicle at a constant speed is an angle included in a range of, for example, 4 to 10°. A maximum joint angle φ2 of the tripod type constant velocity universal joint 1 during acceleration or deceleration of the vehicle traveling straightforward can have an angle range larger than that of the maximum joint angle φ1. The maximum joint angle φ2 is included in a range of, for example, 6 to 20°. A maximum joint angle φ3 of the tripod type constant velocity universal joint 1 during maximum steering can have an angle range larger than those of the maximum joint angles φ1, φ2. The maximum joint angle φ3 is included in a range of, for example, 10 to 25°.

### 3. Outline of Groove-orthogonal Sectional Shape of Ceiling Surface 13

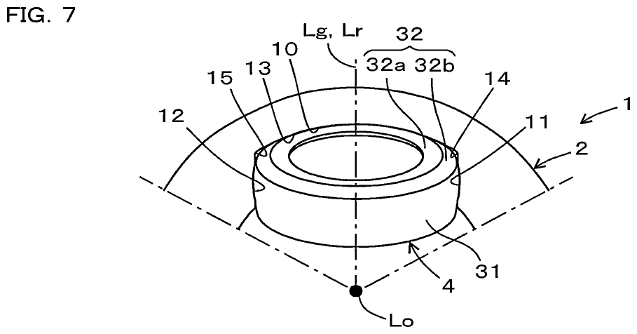

The outline of the groove-orthogonal sectional shape of the ceiling surface 13 of the raceway groove 10 of the outer ring 2 will be described with reference to FIGS. 6 and 7. The groove-orthogonal sectional shape of the ceiling surface 13 is determined using the shape of the roller 4 when the roller 4 pitches by a predetermined angle θp2 as shown in FIG. 6. When the roller 4 pitches by the predetermined angle θp2, the roller 4 appears as shown in FIG. 7 as viewed in the axial direction of the outer ring 2. The predetermined angle θp2 is a contact pitching angle. This means that the roller 4 can come into contact with the ceiling surface 13 when the roller 4 pitches by the predetermined angle θp2.

The predetermined angle θp2 can be one of the following two types of angle. A first predetermined angle θp2 is set to an angle larger than the maximum joint angle φ1 during straightforward traveling of the vehicle at a constant speed and equal to or smaller than the maximum joint angle φ2 during acceleration or deceleration of the vehicle traveling straightforward. In this case, the first predetermined angle θp2 is naturally an angle smaller than the maximum joint angle φ3 during maximum steering.

In this case, the roller 4 does not come into contact with the ceiling surface 13 when the pitching angle of the roller 4 is the maximum joint angle φ1 during straightforward traveling of the vehicle at a constant speed. The roller 4 comes into contact with the ceiling surface 13 when the pitching angle of the roller 4 is the maximum joint angle φ2 during acceleration or deceleration of the vehicle traveling straightforward. When the pitching angle of the roller 4 is changing to increase, the roller 4 comes into contact with the ceiling surface 13 within the range in which the pitching angle of the roller 4 is larger than φ1 and equal to or smaller than φ2.

A second predetermined angle θp2 is set to an angle larger than the maximum joint angle φ2 during acceleration or deceleration of the vehicle traveling straightforward and equal to or smaller than the maximum joint angle φ3 during maximum steering. In this case, the second predetermined angle θp2 is naturally an angle larger than the maximum joint angle φ1 during straightforward traveling of the vehicle at a constant speed.

In this case, the roller 4 does not come into contact with the ceiling surface 13 when the pitching angle of the roller 4 is the maximum joint angle φ1 during straightforward traveling of the vehicle at a constant speed. Further, the roller 4 does not come into contact with the ceiling surface 13 when the pitching angle of the roller 4 is the maximum joint angle φ2 during acceleration or deceleration of the vehicle traveling straightforward. The roller 4 comes into contact with the ceiling surface 13 when the pitching angle of the roller 4 is the maximum joint angle φ3 during maximum steering. When the pitching angle of the roller 4 is changing to increase, the roller 4 comes into contact with the ceiling surface 13 within the range in which the pitching angle of the roller 4 is larger than φ2 and equal to or smaller than φ3.

When the roller 4 is not in contact with the ceiling surface 13, a clearance is present between the roller 4 and the ceiling surface 13. Therefore, as the range of the pitching angle at which the roller 4 is not in contact with the ceiling surface 13 increases, the generation of a forcing power can be suppressed more in the range in which the roller 4 reaches a large pitching angle. As the pitching angle at which the roller 4 is not in contact with the ceiling surface 13 increases, the size of the outer ring 2 increases. Therefore, the range of the pitching angle at which the roller 4 is not in contact with the ceiling surface 13 is not increased excessively and the range in which the generation of the forcing power can be suppressed is minimized. Thus, the effects of downsizing and suppression of the forcing power can be attained.

### 4. Details of Groove-orthogonal Sectional Shape of Ceiling Surface 13

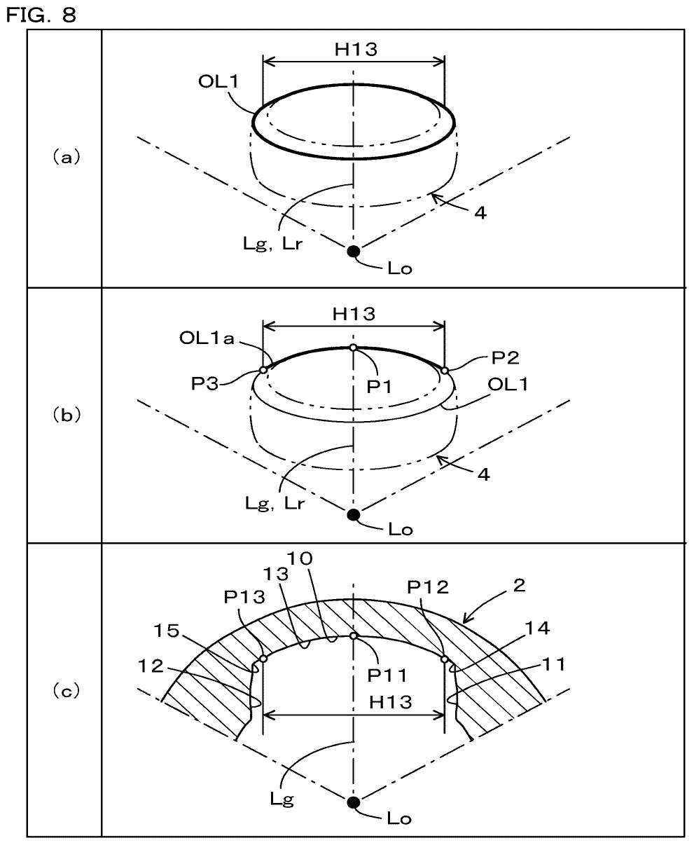

Details of the groove-orthogonal sectional shape of the ceiling surface 13 will be described with reference to FIG. 8. As shown in FIG. 8(a), a contour line OL1 obtained by projecting the roller end face 32 in the axial direction of the outer ring 2 when the roller 4 pitches by the predetermined angle θp2 has a shape indicated by a wide continuous line. In the present embodiment, part of the contour line OL1 is defined by a boundary line between the circular flat portion 32a and the chamfered portion 32b, and the other part of the contour line OL1 is defined by a boundary line between the chamfered portion 32b and the roller outer circumferential surface 31. In FIG. 8(a), H13 is a range of the ceiling surface 13.

In FIG. 8(b), a target contour line OL1a located away from the central axis Lo of the outer ring 2 in the contour line OL1 within the range H13 of the ceiling surface 13 is indicated by a wide continuous line. The target contour line OL1a passes through a central highest point P1 located on the central axis Lr of the roller 4 on the contour line OL1. Further, the target contour line OL1a is a line connecting one end point P2 and the other end point P3 located at both ends of the range H13 of the ceiling surface 13. That is, the target contour line OL1a is defined by a line shape connecting the central highest point P1 and the one end point P2, and a line shape connecting the central highest point P1 and the other end point P3.

As shown in FIG. 8(c), the groove-orthogonal sectional shape of the ceiling surface 13 is a line shape including at least part of the target contour line OL1a. In the present embodiment, the groove-orthogonal sectional shape of the ceiling surface 13 is a line shape including the entire target contour line OL1a. In the groove-orthogonal sectional shape of the ceiling surface 13 in FIG. 8(c), a point P11 agrees with the central highest point P1, a point P12 agrees with the one end point P2, and a point P13 agrees with the other end point P3.

### 5. Effects

In the tripod type constant velocity universal joint 1 of the present embodiment, the groove-orthogonal sectional shape of the ceiling surface 13 of the raceway groove 10 of the outer ring 2 is the line shape including at least part of the target contour line OL1a. The target contour line OL1a is a line located away from the central axis Lo of the outer ring 2 in the contour line OL1 obtained by projecting the roller end face 32 in the axial direction of the outer ring 2 when the roller 4 pitches by the predetermined angle θp2.

That is, when the roller 4 pitches by the predetermined angle θp2, part of the roller end face 32 comes into contact with the ceiling surface 13 of the raceway groove 10 of the outer ring 2. When the roller 4 pitches by an angle smaller than the predetermined angle θp2, a small clearance is present between the ceiling surface 13 and the roller 4. Thus, the generation of the forcing power can be suppressed when the roller 4 pitches by an angle smaller than the predetermined angle θp2.

When the roller 4 pitches by the predetermined angle θp2, part of the roller 4 comes into contact with the ceiling surface 13, which means that the ceiling surface 13 is positioned closer to the center of the outer ring 2 compared to a case where the groove-orthogonal sectional shape of the ceiling surface 13 is a circular arc shape centered on the central axis Lo of the outer ring 2. Thus, the size of the outer ring 2 can be reduced and, as a result, the weight of the outer ring 2 can be reduced. Furthermore, the size and weight of the tripod type constant velocity universal joint 1 can be reduced.

### Modification of First Embodiment

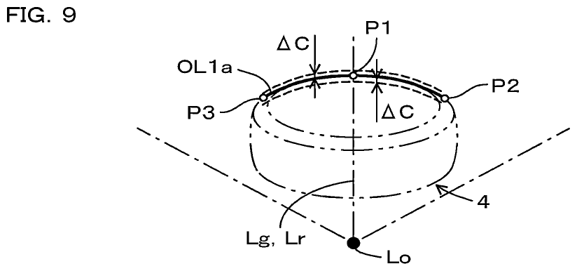

A modification of the first embodiment will be described with reference to FIG. 9. In the first embodiment, the groove-orthogonal sectional shape of the ceiling surface 13 is the line shape that completely agrees with the target contour line OL1a. Alternatively, the groove-orthogonal sectional shape of the ceiling surface 13 may be a line shape that agrees with only part of the target contour line OL1a.

FIG. 9 shows the target contour line OL1a shown in FIG. 8(b). A line shape having a predetermined clearance ΔC from the target contour line OL1a is indicated by a dashed line. The groove-orthogonal sectional shape of the ceiling surface 13 may be a line shape included within a range of the predetermined clearance ΔC from the target contour line OL1a. For example, the groove-orthogonal sectional shape of the ceiling surface 13 is defined by a line shape connecting the points P1 and P2 by an ellipse or a circular arc and also by a line shape connecting the points P1 and P3 by an ellipse or a circular arc within the range of the predetermined clearance ΔC.

When the groove-orthogonal sectional shape of the ceiling surface 13 is a line shape included within the range of the predetermined clearance ΔC from the target contour line OL1a, the groove-orthogonal sectional shape of the ceiling surface 13 can be a shape that facilitates molding. Particularly when the groove-orthogonal sectional shape of the ceiling surface 13 is a line shape passing through the points P1, P2, P3 within the range of the predetermined clearance ΔC, the size and weight of the outer ring 2 can be reduced.

### Second Embodiment

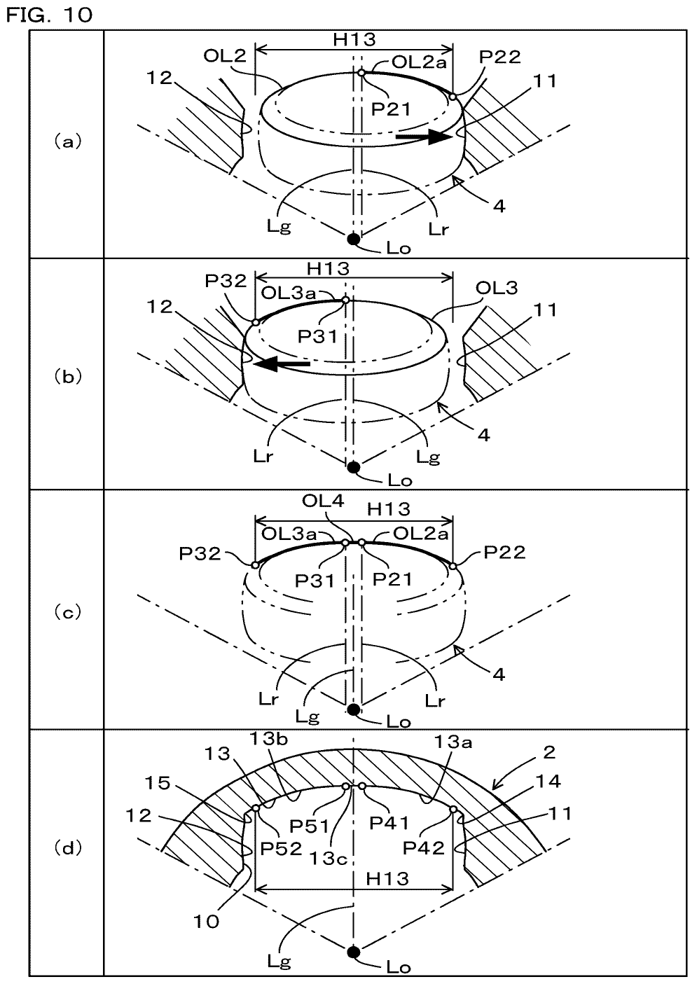

The groove-orthogonal sectional shape of a ceiling surface 13 of a tripod type constant velocity universal joint 1 of a second embodiment will be described with reference to FIG. 10. For ease of the description, the difference between the facing distance between the first raceway surface 11 and the second raceway surface 12 and the width of the roller outer circumferential surface 31 is exaggerated in FIG. 10. In actuality, the difference between the facing distance between the first raceway surface 11 and the second raceway surface 12 and the width of the roller outer circumferential surface 31 is very small.

As shown in FIG. 10(a), torque is transmitted between the roller 4 and the first raceway surface 11. In FIG. 10(a), a first contour line OL2 obtained by projecting the roller end face 32 in the axial direction of the outer ring 2 when the roller 4 pitches by the predetermined angle θp2 and the roller outer circumferential surface 31 comes into contact with the first raceway surface 11 and has a clearance from the second raceway surface 12 has a shape indicated by a continuous line.

As shown in FIG. 10(a), a first target contour line OL2a located away from the central axis Lo of the outer ring 2 and closer to the first raceway surface 11 with respect to the central axis Lr of the roller 4 in the first contour line OL2 within the range H13 of the ceiling surface 13 is indicated by a wide continuous line. The first target contour line OL2a is defined by a line shape connecting a first central highest point P21 located on the central axis Lr of the roller 4 and one end point P22 of the range H13 of the ceiling surface 13 in the first contour line OL2.

Next, as shown in FIG. 10(b), torque is transmitted between the roller 4 and the second raceway surface 12. In FIG. 10(b), a second contour line OL3 obtained by projecting the roller end face 32 in the axial direction of the outer ring 2 when the roller 4 pitches by the predetermined angle θp2 and the roller outer circumferential surface 31 comes into contact with the second raceway surface 12 and has a clearance from the first raceway surface 11 has a shape indicated by a continuous line.

As shown in FIG. 10(b), a second target contour line OL3a located away from the central axis Lo of the outer ring 2 and closer to the second raceway surface 12 with respect to the central axis Lr of the roller 4 in the second contour line OL3 within the range H13 of the ceiling surface 13 is indicated by a wide continuous line. The second target contour line OL3a is defined by a line shape connecting a second central highest point P31 located on the central axis Lr of the roller 4 and the other end point P32 of the range H13 of the ceiling surface 13 in the second contour line OL3.

As shown in FIG. 10(c), a straight shape connecting the first target contour line OL2a and the second target contour line OL3a by a straight line is represented by OL4. That is, the straight shape OL4 is a straight line connecting the first central highest point P21 serving as the end point of the first target contour line OL2a and the second central highest point P31 serving as the end point of the second target contour line OL3a.

As shown in FIG. 10(d), the groove-orthogonal sectional shape of the ceiling surface 13 is defined by a line shape including at least part of the first target contour line OL2a and a line shape including the second target contour line OL3a. In the present embodiment, the groove-orthogonal sectional shape of the ceiling surface 13 is defined by the straight shape OL4 in addition to a line shape including the entire first target contour line OL2a and a line shape including the second target contour line OL3a.

In the groove-orthogonal sectional shape of the ceiling surface 13 in FIG. 10(d), a point P41 agrees with the first central highest point P21 of the first target contour line OL2a, and a point P41 agrees with the end point P22 of the first target contour line OL2a. A first ceiling surface portion 13a that is part of the ceiling surface 13 agrees with the first target contour line OL2a. In the groove-orthogonal sectional shape of the ceiling surface 13, a point P51 agrees with the second central highest point P31 of the second target contour line OL3a, and a point P51 agrees with the end point P32 of the second target contour line OL3a. A second ceiling surface portion 13b that is part of the ceiling surface 13 agrees with the second target contour line OL3a. A third ceiling surface portion 13c that is part of the ceiling surface 13 agrees with the straight shape OL4.

According to the present embodiment, when the roller outer circumferential surface 31 is in contact with one of the first raceway surface 11 and the second raceway surface 12 and has a clearance from the other, the groove-orthogonal sectional shape of the ceiling surface 13 can be set to a shape in consideration of the clearance. Thus, it is possible to reduce the size and weight of the outer ring 2 in consideration of the clearance.

### Modification of Second Embodiment

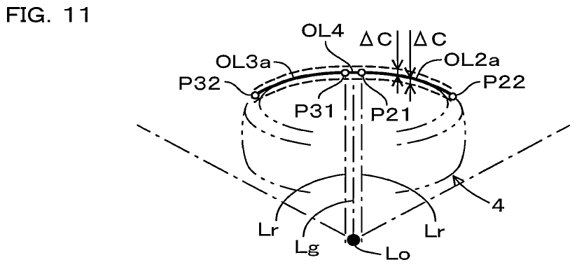

A modification of the second embodiment will be described with reference to FIG. 11. In the second embodiment, the groove-orthogonal sectional shape of the ceiling surface 13 is the line shape that completely agrees with the first target contour line OL2a, the second target contour line OL3a, and the straight shape OL4. Alternatively, the groove-orthogonal sectional shape of the ceiling surface 13 may be a line shape that agrees with only part of the first target contour line OL2a and the second target contour line OL3a.

FIG. 11 shows the first target contour line OL2a, the second target contour line OL3a, and the straight shape OL4 shown in FIG. 10(c). A line shape having a predetermined clearance AC from the first target contour line OL2a, the second target contour line OL3a, and the straight shape OL4 is indicated by a dashed line. The groove-orthogonal sectional shape of the ceiling surface 13 may be a line shape included within a range of the predetermined clearance AC from the first target contour line OL2a, the second target contour line OL3a, and the straight shape OL4.

For example, the groove-orthogonal sectional shape of the ceiling surface 13 is defined by a line shape connecting the points P21 and P22 by an ellipse or a circular arc and also by a line shape connecting the points P31 and P32 by an ellipse or a circular arc within the range of the predetermined clearance AC. The groove-orthogonal sectional shape of the ceiling surface 13 agrees with the straight shape OL4.

When the groove-orthogonal sectional shape of the ceiling surface 13 is the line shape described above, the groove-orthogonal sectional shape of the ceiling surface 13 can be a shape that facilitates molding. Particularly when the groove-orthogonal sectional shape of the ceiling surface 13 is a line shape passing through the points P21, P22, P31, P32 within the range of the predetermined clearance AC, the size and weight of the outer ring 2 can be reduced.

1. A tripod type constant velocity universal joint comprising:
an outer ring having a plurality of raceway grooves extending in an axial direction;
a tripod including a plurality of tripod shaft portions extending radially outward; and
rollers externally fitted onto the tripod shaft portions and configured to roll in the raceway grooves, wherein:
the raceway groove includes a first raceway surface constituting one groove side surface, a second raceway surface constituting another groove side surface, and a ceiling surface constituting a groove bottom surface;
the roller includes
a roller outer circumferential surface configured to roll on the first raceway surface or the second raceway surface, and
a roller end face that is an axial end face of the roller that faces the ceiling surface; and
a groove-orthogonal sectional shape of the ceiling surface is a line shape including at least part of a target contour line located away from a central axis of the outer ring in a contour line obtained by projecting the roller end face in the axial direction of the outer ring when the roller pitches by a predetermined angle.

2. The tripod type constant velocity universal joint according to claim 1, wherein the groove-orthogonal sectional shape of the ceiling surface is a line shape included within a range of a predetermined clearance from the target contour line.

3. The tripod type constant velocity universal joint according to claim 1, wherein:
the contour line includes
a first contour line obtained by projecting the roller end face in the axial direction of the outer ring when the roller pitches by the predetermined angle and the roller outer circumferential surface comes into contact with the first raceway surface and has a clearance from the second raceway surface, and
a second contour line obtained by projecting the roller end face in the axial direction of the outer ring when the roller pitches by the predetermined angle and the roller outer circumferential surface comes into contact with the second raceway surface and has a clearance from the first raceway surface; and
the groove-orthogonal sectional shape of the ceiling surface is defined by
a line shape including at least part of a first target contour line located away from the central axis of the outer ring and closer to the first raceway surface with respect to a central axis of the roller in the first contour line, and
a line shape including at least part of a second target contour line located away from the central axis of the outer ring and closer to the second raceway surface with respect to the central axis of the roller in the second contour line.

4. The tripod type constant velocity universal joint according to claim 3, wherein the groove-orthogonal sectional shape of the ceiling surface is defined by a line shape included within a range of a predetermined clearance from the first target contour line, and a line shape included within a range of the predetermined clearance from the second target contour line.

5. The tripod type constant velocity universal joint according to claim 3, wherein the groove-orthogonal sectional shape of the ceiling surface is further defined by a straight shape connecting the first target contour line and the second target contour line by a straight line.

6. The tripod type constant velocity universal joint according to claim 1, wherein the predetermined angle is an angle larger than a maximum joint angle of the tripod type constant velocity universal joint during straightforward traveling of a vehicle at a constant speed.

7. The tripod type constant velocity universal joint according to claim 6, wherein the maximum joint angle of the tripod type constant velocity universal joint during the straightforward traveling of the vehicle at the constant speed is an angle included in a range of 4 to 10°.

8. The tripod type constant velocity universal joint according to claim 6, wherein the predetermined angle is an angle larger than a maximum joint angle of the tripod type constant velocity universal joint during acceleration or deceleration of the vehicle traveling straightforward.

9. The tripod type constant velocity universal joint according to claim 6 or 7, wherein the predetermined angle is an angle equal to or smaller than a maximum joint angle of the tripod type constant velocity universal joint during acceleration or deceleration of the vehicle traveling straightforward.

10. The tripod type constant velocity universal joint according to claim 8, wherein the maximum joint angle of the tripod type constant velocity universal joint during the acceleration or deceleration of the vehicle traveling straightforward is an angle included in a range of 6 to 20°.

11. The tripod type constant velocity universal joint according to claim 1, wherein the predetermined angle is an angle smaller than a maximum joint angle of the tripod type constant velocity universal joint during maximum steering.

12. The tripod type constant velocity universal joint according to claim 11, wherein the maximum joint angle of the tripod type constant velocity universal joint during the maximum steering is an angle included in a range of 10 to 25°.

13. The tripod type constant velocity universal joint according to claim 1, wherein the raceway groove includes the first raceway surface, the second raceway surface, the ceiling surface, a first recessed surface connecting the first raceway surface and the ceiling surface, and a second recessed surface connecting the second raceway surface and the ceiling surface.

14. The tripod type constant velocity universal joint according to claim 1, wherein the roller is externally fitted onto the tripod shaft portion so that the roller is tiltable relative to the tripod shaft portion.

15. The tripod type constant velocity universal joint according to claim 9, wherein the maximum joint angle of the tripod type constant velocity universal joint during the acceleration or deceleration of the vehicle traveling straightforward is an angle included in a range of 6 to 20°.
